(19) United States
(12) Patent Application Publication
(10) Pub. No.: US 2025/0013097 A1
(43) Pub. Date: Jan. 9, 2025

(54) REFLECTIVE DISPLAYS INCLUDING REFLECTORS

(71) Applicant: CORNING INCORPORATED, Corning, NY (US)

(72) Inventors: Valentin Alexandrovich Averchenko, Espoo (FI); Tomohiro Ishikawa, Corning, NY (US); Sergey Anatol'evich Kuchinsky, Helsinki (FI); Antoine Daniel Emmanuel Lesuffleur, Avon (FR); Michal Mlejnek, Big Flats, NY (US); Nikolay Timofeyevich Timofeev, St. Petersburg (RU)

(21) Appl. No.: 18/711,195

(22) PCT Filed: Dec. 2, 2021
(86) PCT No.: PCT/RU2021/000536

§ 371 Date: May 17, 2024

(51) Int. Cl. G02F 1/1335

(52) U.S. Cl. CPC G02F 1/133553; G02F 1/133565

(57) ABSTRACT

A reflective display includes a plurality of pixels, where each pixel includes an active area. The reflective display includes an array of reflectors within the active area of each pixel. Each reflector of the array of reflectors is directly adjacent to another reflector of the array of reflectors. Each reflector of the array of reflectors is entirely reflective, and each reflector of the array of reflectors includes a curved first surface.

### BACKGROUND

### Field

The present disclosure relates generally to displays. More particularly, it relates to reflective displays including reflectors.

### Technical Background

Reflective displays, such as reflective liquid crystal displays (RLCDs), do not include a back-lighting unit. Rather, the reflective displays are viewable by reflecting ambient light from external sources, such as the sun, lamps, etc. Reflective displays are attractive due to their low energy consumption. There are many applications for reflective displays, such as mobile phones, e-readers, and public signage. Since there is no back-lighting unit, management of the incoming light determines the brightness of the images displayed on the reflective displays.

### SUMMARY

Some embodiments of the present disclosure relate to a reflective display. The reflective display includes a plurality of pixels, where each pixel includes an active area. The reflective display includes an array of reflectors within the active area of each pixel. Each reflector of the array of reflectors is directly adjacent to another reflector of the array of reflectors. Each reflector of the array of reflectors is entirely reflective, and each reflector of the array of reflectors includes a curved first surface.

Yet other embodiments of the present disclosure relate to a reflective display. The reflective display includes a plurality of pixels, where each pixel includes an active area. The reflective display includes an array of reflectors within the active area of each pixel. Each reflector of the array of reflectors is directly adjacent to another reflector of the array of reflectors. Each reflector of the array of reflectors is entirely reflective, and each reflector of the array of reflectors includes a first surface having a first slope and a second surface having a second slope different from the first slope.

Yet other embodiments of the present disclosure relate to a reflective display. The reflective display includes a plurality of pixels, where each pixel includes an active area. The reflective display includes an array of reflectors within the active area of each pixel. Each reflector of the array of reflectors is directly adjacent to another reflector of the array of reflectors, and each reflector of the array of reflectors includes an inverted pyramid or cone.

The reflective displays disclosed herein may be fabricated by forming each array of reflectors on a substrate (e.g., glass) using a precision microreplication by thermal or monomer cross-linking process. Each array of reflectors has a unit geometry optimized to redirect the incoming light to the viewer(s) depending on the application. The horizontal spread of the redirected light may be adjusted by changing the unit geometry. Depending upon the application, the diffusivity of the redirected light may be controlled based on the orientation distribution of the unit geometry. In addition, potential Moiré may be mitigated by orientation distribution of the unit geometry. The controlled viewing angle of the reflective displays also provides a privacy feature for larger viewing angles, i.e., the display is visible only within given viewing angles.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary and are intended to provide an overview or framework to understanding the nature and character of the claims. The accompanying drawings are included to provide a further understanding and are incorporated in and constitute a part of this specification. The drawings illustrate one or more embodiment(s), and together with the description explain principles and operation of the various embodiments.

### BRIEF DESCRIPTION OF THE DRAWINGS

FIG. 1 is a schematic diagram illustrating an exemplary reflective display, light source, and viewer;

FIGS. 2A and 2B are schematic diagrams illustrating exemplary use cases for reflective displays;

FIGS. 3A-3F are schematic diagrams illustrating exemplary light illuminations for a reflective display;

FIG. 4 is an angular plot illustrating a directional distribution of reflection;

FIG. 5 illustrates different views of an exemplary reflector;

FIG. 6A is a top view illustrating an exemplary reflective display;

FIGS. 6B-6D are cross-sectional views of exemplary reflective displays;

FIGS. 7A and 7B are a top view and a side view of a pixel of an exemplary reflective display;

FIG. 7C is an angular plot illustrating a directional distribution of reflection for the reflective display of FIGS. 7A and 7B;

FIG. 8A is a top view of a pixel of another exemplary reflective display;

FIG. 8B illustrates an exemplary reflector design for the reflective display of FIG. 8A;

FIG. 8C is an angular plot illustrating a directional distribution of reflection for the reflector design of FIG. 8B;

FIG. 9A is a top view of a pixel of another exemplary reflective display;

FIG. 9B illustrates an exemplary reflector design for the reflective display of FIG. 9A;

FIG. 9C is an angular plot illustrating a directional distribution of reflection for the reflector design of FIG. 9B;

FIG. 9D illustrates another exemplary reflector design for the reflective display of FIG. 9A;

FIG. 9E is an angular plot illustrating a directional distribution of reflection for the reflector design of FIG. 9D;

FIG. 10A is a top view of a pixel of another exemplary reflective display;

FIG. 10B illustrates an exemplary reflector design for the reflective display of FIG. 10A;

FIG. 10C is an angular plot illustrating a directional distribution of reflection for the reflector design of FIG. 10B;

FIG. 11A is a top view of a pixel of another exemplary reflective display;

FIGS. 11B and 11C are angular plots illustrating exemplary directional distributions for the reflective display of FIG. 11A;

FIGS. 12A and 12B are cross-sectional views of other exemplary reflectors;

FIGS. 13A and 13B illustrate exemplary inverted pyramid reflectors;

FIGS. 13C and 13D are charts illustrating exemplary angular distributions of the outcoupled light intensity for the inverted pyramid reflectors of FIGS. 13A and 13B.

FIGS. 14A and 14B illustrate exemplary inverted cone reflectors; and

FIG. 14C is a chart illustrating an exemplary angular distribution of the outcoupled light intensity for the inverted cone reflectors of FIGS. 14A and 14B.

### DETAILED DESCRIPTION

Reference will now be made in detail to embodiments of the present disclosure, examples of which are illustrated in the accompanying drawings. Whenever possible, the same reference numerals will be used throughout the drawings to refer to the same or like parts. However, this disclosure may be embodied in many different forms and should not be construed as limited to the embodiments set forth herein.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example up, down, right, left, front, back, top, bottom, vertical, horizontal—are made only with reference to the figures as drawn and are not intended to imply absolute orientation.

Unless otherwise expressly stated, it is in no way intended that any method set forth herein be construed as requiring that its steps be performed in a specific order, nor that with any apparatus, specific orientations be required. Accordingly, where a method claim does not actually recite an order to be followed by its steps, or that any apparatus claim does not actually recite an order or orientation to individual components, or it is not otherwise specifically stated in the claims or description that the steps are to be limited to a specific order, or that a specific order or orientation to components of an apparatus is not recited, it is in no way intended that an order or orientation be inferred, in any respect. This holds for any possible non-express basis for interpretation, including: matters of logic with respect to arrangement of steps, operational flow, order of components, or orientation of components; plain meaning derived from grammatical organization or punctuation, and; the number or type of embodiments described in the specification.

As used herein, the singular forms “a,” “an,” and “the” include plural references unless the context clearly dictates otherwise. Thus, for example, reference to “a” component includes aspects having two or more such components, unless the context clearly indicates otherwise.

Redirection of reflected light in reflective displays may be characterized by two factors including luminosity in the viewer(s) direction and horizontal spread. Horizontal spread is the spread of light in the plane perpendicular to the incident plane. Light reflection in a reflective display may be controlled by a bump-like reflective texture fabricated using photolithography inside of a liquid crystal display (LCD) cell. This bump-like reflective texture may be referred to as an isotropic in-cell reflector (IICR). Light reflection in a reflective display may also be controlled by an index/birefringent gradient film to guide the light. This index/birefringent gradient film may be referred to as light controlling film (LCF). IICR and LCF, however, have several disadvantages that result in unsatisfactory performance in applications. The photolithography used for IICR and the following etching forms only symmetric reflective textures (e.g., semispherical). Thus, in IICR, light reflected to the viewer(s) has a limited direction. In addition, no control of the reflective surface curvature is possible. LCF may achieve a desired retroflected property, however, LCF may have a parallax problem as the film is laminated outside of the reflective display front glass and polarizer. In addition, LCF introduces birefringence and lowers the contrast ratio of the reflective display. Accordingly, disclosed herein are reflective displays including reflectors that do not have the disadvantages of IICR and LCF.

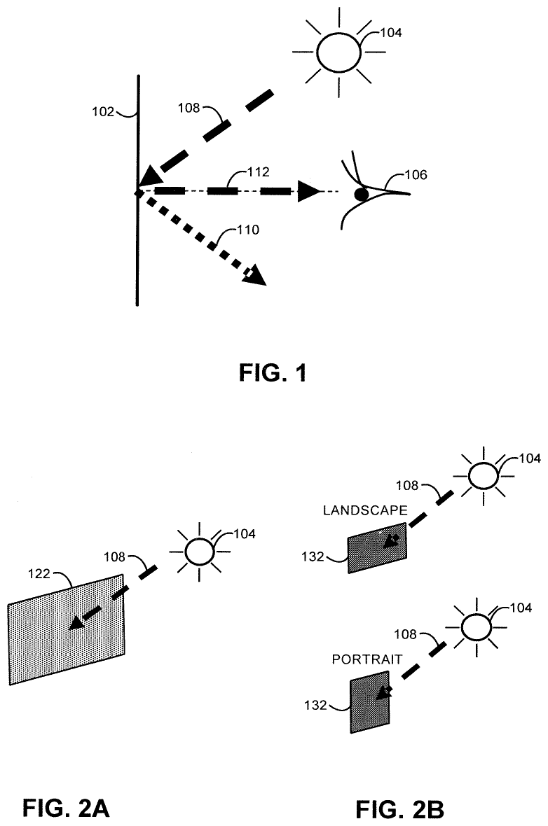

Referring now to FIG. 1, a schematic diagram illustrating an exemplary reflective display 102, light source 104, and viewer 106 is depicted. FIG. 1 depicts an ideal operation mode of the reflective display 102. Light from light source 104 is incident on the reflective display 102 as indicated at 108. If no means of redirection are present in reflective display 102, the image light is reflected to the specular direction as indicated at 110 and no image light reaches the viewer's eye 106. If means of redirection are present in reflective display 102, the image light is reflected to the viewer's eye 106 as indicated at 112. Thus, reflective display 102 should include reflection control means to redirect light to a viewer. The properties of such reflection control means depends on the condition of the light source 104, use cases for the reflective display 102, and the desired spread of the reflected light.

FIGS. 2A and 2B are schematic diagrams illustrating exemplary use cases for reflective displays. FIG. 2A includes a reflective display 122 and a light source 104. In this example, reflective display 122 is fixed such that the reflective display 122 cannot be rotated. Reflective display 122 may be, for example, a public sign. In this case, the direction of the incident light from light source 104 as indicated at 108 is fixed with respect to the orientation of reflective display 122. FIG. 2B includes a reflective display 132 and a light source 104 in both a landscape orientation and a portrait orientation. In this example, reflective display 132 is not fixed such that reflective display 132 can be rotated. Reflective display 132 may be, for example, a portable device. In this case, the direction of the incident light from light source 104 as indicated at 108 is not fixed with respect to the orientation of the reflective display 132. Each reflective display 122 and 132 includes a different symmetry in the reflector geometry. In addition, each reflective display 122 and 132 controls the spread of the reflection to optimize the use of the incoming light.

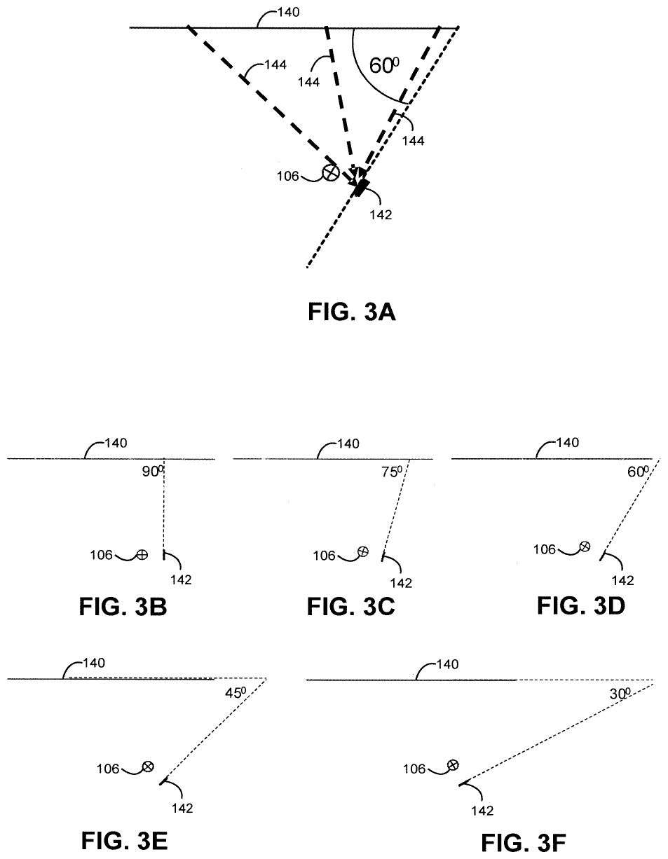

FIG. 3A-3F illustrate different light illuminations of a reflective display 142. An emitting surface 140 directs ambient light to the reflective display 142, which may have various angular orientations. The viewer of reflective display 142 is indicated at 106. The emitting surface 140 may be a ceiling, wall, window, etc. where light rays 144 come from the emitting surface. FIG. 3A illustrates how ambient light illuminates a reflective display 142 when not considering direct light, such as direct sunlight for example. In such case, the diffusion profile of the ambient light, the directionality of the ambient light, and the orientation of the reflective display 142 relative to the emitting surface 140 are parameters that affect the light reflected from the reflective display. In FIG. 3A, reflective display 142 is oriented at about a 60 degree angle with respect to the emitting surface 140. In FIG. 3B, reflective display 142 is oriented at about a 90 degree angle with respect to the emitting surface 140. In FIG. 3C, reflective display 142 is oriented at about a 75 degree angle with respect to the emitting surface 140. In FIG. 3D, reflective display 142 is oriented at about a 60 degree angle with respect to the emitting surface 140. In FIG. 3E, reflective display 142 is oriented at about a 45 degree angle with respect to the emitting surface 140. In FIG. 3F, reflective display 142 is oriented at about a 30 degree angle with respect to the emitting surface 140. In other examples, other orientations of reflective display 142 with respect to the emitting surface 140 are possible.

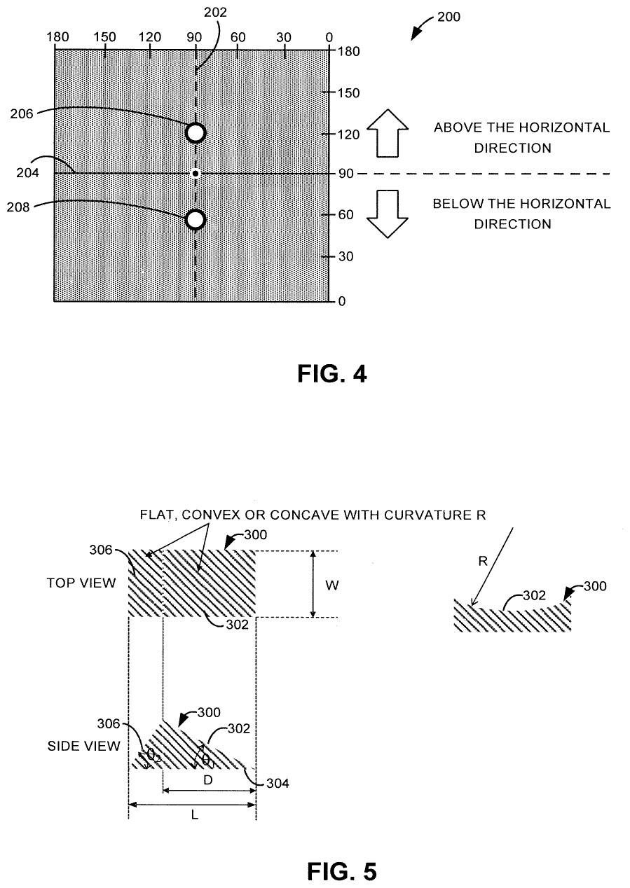

FIG. 4 is an angular plot 200 illustrating a directional distribution of reflection in degrees. Vertical line 202 indicates the azimuth or plane of incidence, while horizontal line 204 is a reading direction (perpendicular to 202). Point 206 corresponds to the direction of incident light (about 30 degrees from the display normal), and point 208 corresponds to specular reflection. IICR reflects most of the light to the direction below the horizontal direction, which is not utilized for viewing. LCF redirects more light into a useful direction (not shown), but the use of LCF often leads to a lower contrast ratio due to birefringence. The reflective displays disclosed herein solve the problems of IICR and LCF described above and offer improved controllability of the reflected light distribution.

FIG. 5 illustrates different views of an exemplary reflector 300. Reflector 300 has an asymmetric geometry including a reflecting first surface 302, a planar second surface 304 extending to the first surface 302, and a third surface 306 extending between the first surface 302 and the second surface 304. Reflector 300 is defined by a total length L, a width W, a reflector portion length D, a first angle θ₁, a second angle θ₂, and a first surface 302 curvature R. The first surface 302 curvature may be convex or concave. Adjustment of parameters L, D, θ₁, θ₂, W, and R control the angular range of reflection for a given ambient light input. Reflector 300 (e.g., the first surface 302 of reflector 300) is entirely reflective (i.e., 100 percent reflective, 0 percent transmissive). In certain exemplary embodiments, reflector 300 may be made of organic materials. In other embodiments, reflector 300 may be made of inorganic materials to sustain the temperature treatment of thin-film transistors and color filter processes. The first surface 302 and the third surface 306 of reflector 300 may be coated with a reflective material (e.g., metal). Reflector 300 may be fabricated on a substrate (e.g., glass) having a planar surface such that the second surface 304 of reflector 300 contacts the substrate. The second surface 304 of the reflector 300 may be rectangular. A first angle θ₁ between the first surface 302 and the second surface 304 is less than a second angle θ₂ between the second surface 304 and the third surface 306.

In certain exemplary embodiments, the total length L may be within a range between about 5 micrometers and about 250 micrometers. The reflector portion length D may be within a range between about 10 micrometers and about 230 micrometers. The first angle θ₁ may be within a range between about 5 degrees and about 30 degrees. The second angle θ₂ may be within a range between about 60 degrees and about 85 degrees. The width W may be within a range between about 2 micrometers and about 80 micrometers. In other embodiments, L, D, θ₁, θ₂, and W may have other suitable values based on the particular application. The curvature R and/or a distribution of slopes of the reflecting surface may vary based on the particular application and the size of the reflector. In certain exemplary embodiments, the reflector may include a single flat facet or multiple flat facets.

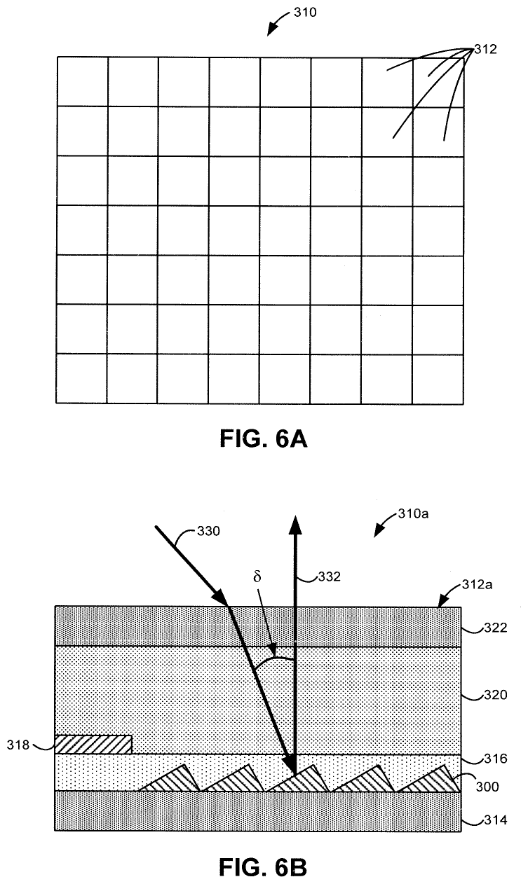

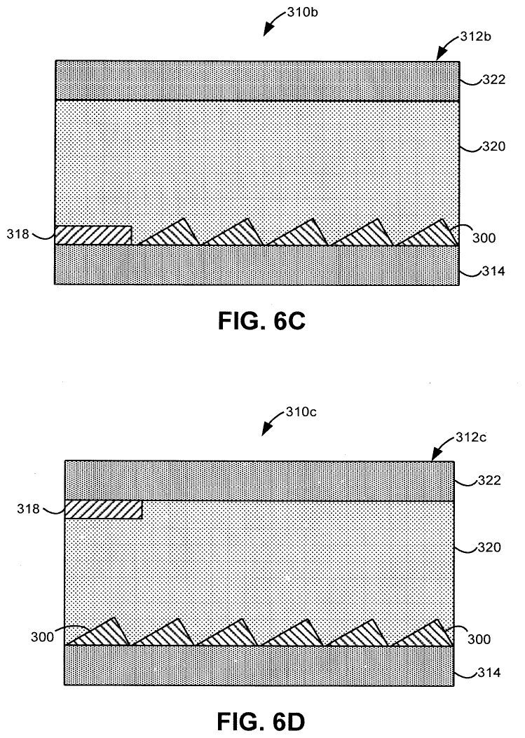

FIG. 6A is a top view illustrating an exemplary reflective display 310. Reflective display 310 includes a plurality of pixels 312. The plurality of pixels 312 are arranged in rows and columns. Reflective display 310 may include any suitable number of rows and any suitable number of columns of pixels 312. In certain exemplary embodiments, the number of rows may be equal the number of columns. In other embodiments, the number of rows may not equal the number of columns.

FIG. 6B is a cross-sectional view of an exemplary reflective display 310a. In this embodiment, reflective display 310a includes a plurality of pixels 312a (one pixel is illustrated in FIG. 6B). Each pixel 312a of reflective display 310a includes a first substrate (e.g., glass substrate) 314, an array of reflectors 300 arranged on the first substrate 314, a planarization layer 316 encapsulating the array of reflectors 300, a thin-film device 318 (e.g., thin-film transistor) arranged on the planarization layer 316, a second substrate 322 (e.g., glass substrate), and a liquid crystal layer 320 between the planarization layer 316 and the second substrate 322. In this embodiment, incoming light as indicated at 330 is redirected toward the viewer as indicated at 332 by reflectors 300. Reflectors 300 redirect the incoming light at an angle δ such that the reflected light 332 is normal to the reflective display 310a.

FIG. 6C is a cross-sectional view of an exemplary reflective display 310b. In this embodiment, reflective display 310b includes a plurality of pixels 312b (one pixel is illustrated in FIG. 6C). Each pixel 312b of reflective display 310b includes a first substrate (e.g., glass substrate) 314, an array of reflectors 300 arranged on the first substrate 314, a thin-film device 318 (e.g., thin-film transistor) arranged on the first substrate 314 proximate (e.g., adjacent) the array of reflectors 300, a second substrate 322 (e.g., glass substrate), and a liquid crystal layer 320 between the first substrate 314 and the second substrate 322. Notably, reflective display 310b does not include a planarization layer such that the array of reflectors 300 directly contacts the liquid crystal layer 320. The planarization layer may be excluded when the height of reflectors 300 is sufficiently low (e.g., less than about 1 micrometer).

FIG. 6D is a cross-sectional view of an exemplary reflective display 310c. In this embodiment, reflective display 310c includes a plurality of pixels 312c (one pixel is illustrated in FIG. 6D). Each pixel 312c of reflective display 310c includes a first substrate (e.g., glass substrate) 314, an array of reflectors 300 arranged on the first substrate 314, a second substrate 322 (e.g., glass substrate), a thin-film device 318 (e.g., thin-film transistor) arranged on the second substrate 322 opposite the array of reflectors 300, and a liquid crystal layer 320 between the first substrate 314 and the second substrate 322.

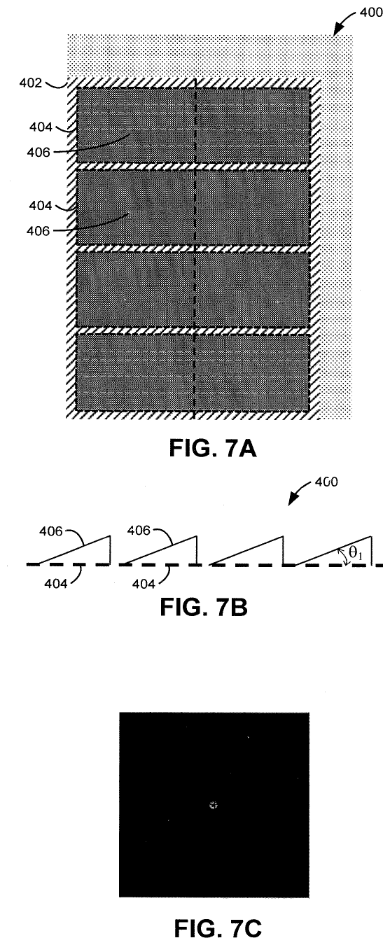

FIGS. 7A and 7B are a top view and a side view, respectively, of a pixel 400 of an exemplary reflective display. In this embodiment, pixel 400 is one pixel of a fixed reflective display, such as fixed display 122 of FIG. 2A. Pixel 400 includes an active area 402 (e.g., the area within the pixel that is driven by an applied electric field) and an array of reflectors 404. Each reflector 404 may be similar to reflector 300 previously described and illustrated with reference to FIG. 5. The reflectors 404 are uniformly arranged within the pixel 400. In this embodiment, each reflector 404 includes a planar reflective first surface 406 (e.g., 0 curvature). The first angle θ₁ of the each reflector 404 equals δ/2. With a planar reflective surface 406, the incoming light is reflected into the viewer's direction without any spread in the horizontal direction as shown as a single reflection point in the angular plot of FIG. 7C.

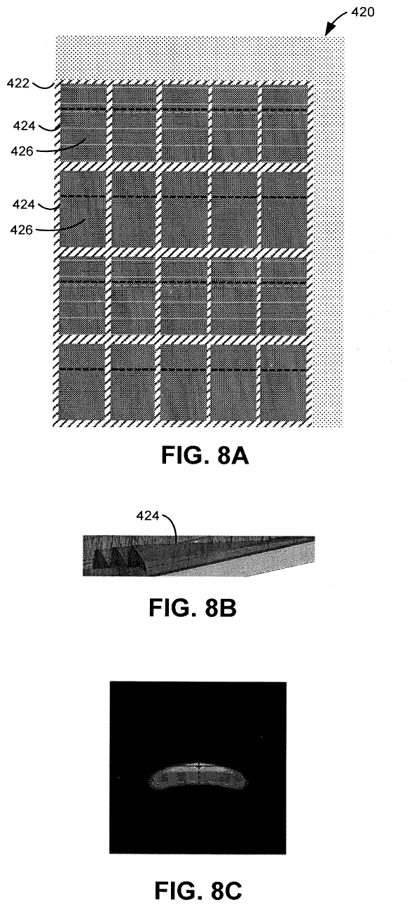

FIG. 8A is a top view of a pixel 420 of another exemplary reflective display. In this embodiment, pixel 420 is one pixel of a fixed reflective display, such as fixed display 122 of FIG. 2A. Pixel 420 includes an active area 422 and an array of reflectors 424. Each reflector 424 may be similar to reflector 300 previously described and illustrated with reference to FIG. 5. The reflectors 424 are uniformly arranged within the pixel 420. In this embodiment, each reflector 424 includes a curved reflective first surface 426. The curved first surface 426 may be concave or convex. The reflectors 424 may have a non-periodic shape with a profile using a sine function to spread light around the targeted viewing angle and the slope may be designed to redirect the light from the light source direction to the viewer direction.

FIG. 8B illustrates an exemplary reflector 424 of FIG. 8A where L is about 21.5 micrometers, D is about 21.5 micrometers, θ₁ is greater than about 4 degrees and less than about 11 degrees, θ₂ is about 85 degrees, W is about 21.5 micrometers, the absolute value of R is greater than about 8 micrometers, and the incline angle across W is less than about 25 degrees. With a curved reflective first surface 426, the incoming light is reflected into the viewer's direction with spread in the horizontal direction as shown in the angular plot of FIG. 8C corresponding to reflector 424 of FIG. 8B.

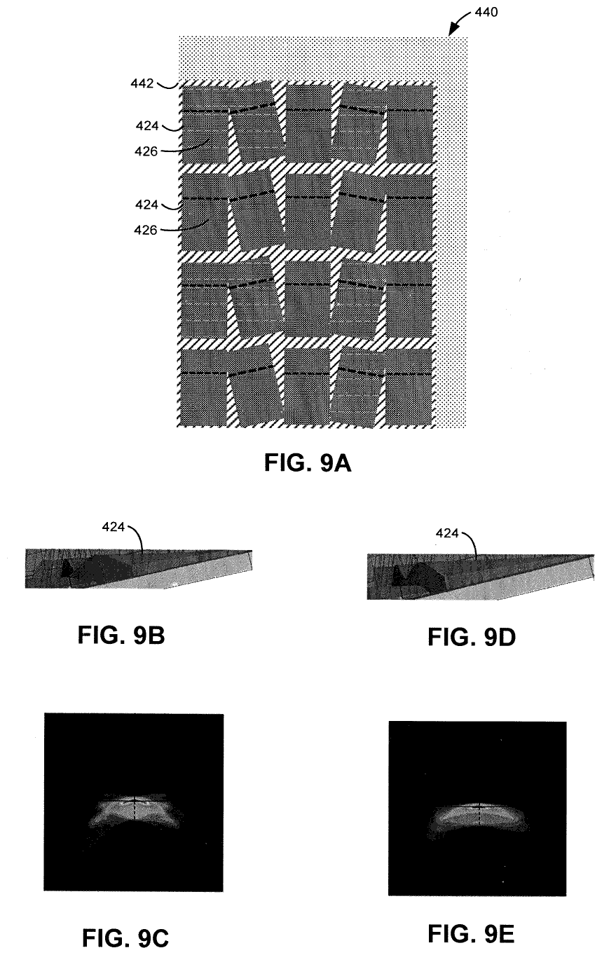

FIG. 9A is a top view of a pixel 440 of another exemplary reflective display. In this embodiment, pixel 440 is one pixel of a fixed reflective display, such as fixed display 122 of FIG. 2A. Pixel 440 includes an active area 442 and an array of reflectors 424 as previously described. In this embodiment, the reflectors 424 are oriented at a random angle within the pixel 420. Each reflector 424 includes a curved reflective first surface 426 as previously described. Each reflector 424 of the array of reflectors is arranged at an angle to a directly adjacent reflector of the array of reflectors within a range between about 5 degrees and about 25 degrees. FIG. 9B illustrates a design for an exemplary reflective display where the reflectors 424 within each row are arranged to have an angle of rotation of about 0 degrees, about −20 degrees, about 0 degrees, about 20 degrees, about 0 degrees, etc., respectively. By varying the orientation of the reflectors 424, top and bottom light spread in the horizontal direction is kept essentially constant as shown in the angular plot of FIG. 9C. The non-uniform arrangement of reflectors 424 minimizes Moiré and optimizes the angular distribution of reflected light. The reflectors 424 may be connected or discrete structures. The reflectors 424 do not need to create a continuous film. In certain exemplary embodiments where the reflectors 424 have a random orientation with respect to adjacent reflectors, discrete units may be desirable. The reflectors 424 may have a sharp edge or a flat top. A flat top allows for front light to be redirected to the viewer. FIG. 9D illustrates a design for another exemplary reflective display where the reflectors 424 within each row are arranged to have an angle of rotation of about 0 degrees, about −10 degrees, about 0 degrees, about 10 degrees, about 0 degrees, etc., respectively. With a curved reflective first surface 426, the incoming light is reflected into the viewer's direction with spread in the horizontal direction as shown in the angular plot of FIG. 9E corresponding to the reflector arrangement of FIG. 9D.

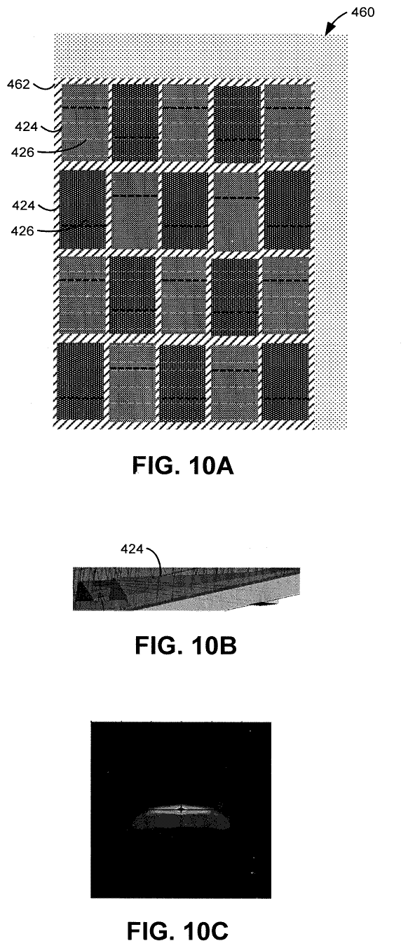

FIG. 10A is a top view of a pixel 460 of another exemplary reflective display. In this embodiment, pixel 460 is one pixel of a fixed reflective display, such as fixed display 122 of FIG. 2A. Pixel 460 includes an active area 462 and an array of reflectors 424 as previously described. In this embodiment, each reflector 424 is oriented opposite to the adjacent reflectors 424 within the pixel 460 (as indicated by the alternating lighter and darker reflectors 424 in FIG. 10A). Each reflector 424 includes a curved reflective first surface 426 as previously described. FIG. 10B illustrates exemplary reflectors 424 arranged opposite to each other as illustrated in FIG. 10A. By orienting each reflector 424 opposite to adjacent reflectors, light is spread above and below in the horizontal direction as shown in the angular plot of FIG. 10C. To achieve the desired behavior in reflection, the average slope of the adjacent reflectors should be maintained.

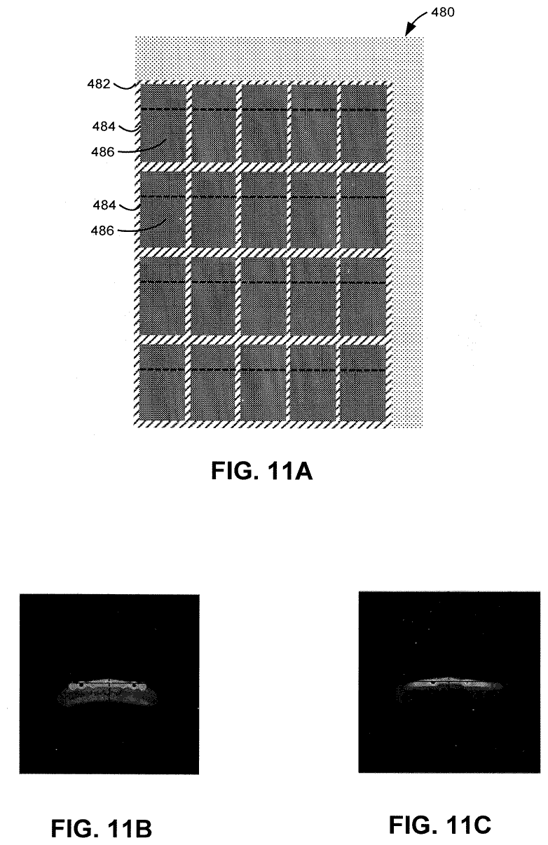

FIG. 11A is a top view of a pixel 480 of another exemplary reflective display. In this embodiment, pixel 480 is one pixel of a fixed reflective display, such as fixed display 122 of FIG. 2A. Pixel 480 includes an active area 482 and an array of reflectors 484. Each reflector 484 may be similar to reflector 300 previously described and illustrated with reference to FIG. 5. In this embodiment, the reflectors 484 are uniformly arranged within the pixel 480. Each reflector 484 includes a segmented reflective surface 486 composed of several reflecting facets distributed across the surface 486 with varying angle of incline along the W direction. FIG. 11B is an angular plot illustrating exemplary directional distributions for the reflective display of FIG. 11A where the reflectors 484 include a tilted polygonal prism shaped first surface 486 (e.g., the angles of incline (slopes) of the facets angle across W are plus or minus about 11.3 degrees, plus or minus about 8.7 degrees, and plus or minus about 4.8 degrees, L is about 22.5 micrometers, D is about 22.5 micrometers, θ₁ is about 9.74 degrees, θ₂ is about 85 degrees, and W is 21.5 micrometers). FIG. 11C is an angular plot illustrating exemplary directional distributions for the reflective display of FIG. 11A where the reflectors 484 include a tilted asymmetric freeform prism shaped first surface 486 (e.g., where L is about 22.5 micrometers, D is about 22.5 micrometers, θ₁ is about 9.74 degrees, W is about 21.5 micrometers, the absolute value of R is less than about 255 micrometers and greater than about 5 micrometers, and the incline angle across W is greater than about 4 micrometers and less than about 40 degrees).

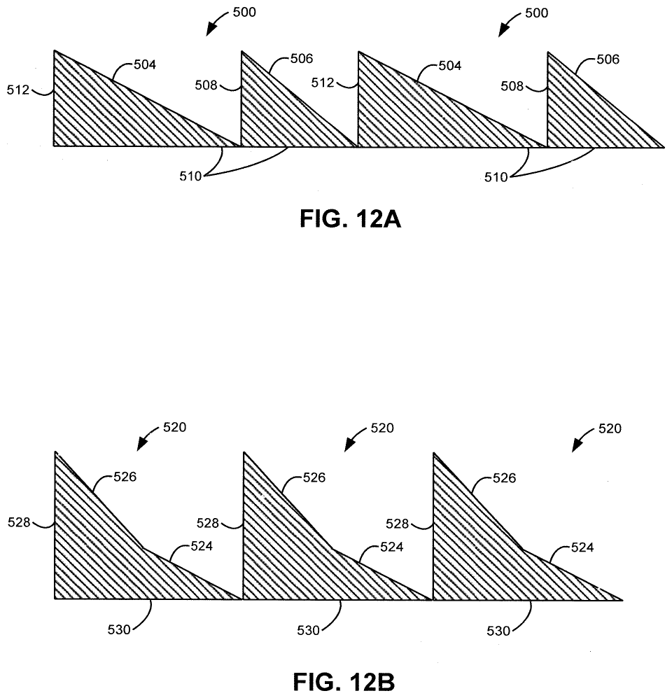

FIG. 12A is a cross-sectional view of exemplary reflectors 500. Reflectors 500 may be used in an array of reflectors within each pixel of a fixed reflective display, such as fixed display 122 of FIG. 2A. Each reflector 500 includes a first surface 504 having a first slope and a second surface 506 having a second slope different from the first slope. In this example, the slope of the first surface 504 is less than the slope of the second surface 506. In certain exemplary embodiments, the first surface 504 and the second surface 506 may be curved (e.g., concave or convex). Each reflector 500 includes a first triangular shaped portion including the first surface 504 and a second triangular shaped portion including the second surface 506. Each reflector 500 also includes a third surface 508 extending between the first surface 504 and the second surface 506. In certain exemplary embodiments, the third surface 508 is perpendicular to the substrate (not shown) on which each reflector 500 is arranged. The angle between a fourth (bottom) surface 510 and the first surface 504 of each reflector 500 may be within a range between about 5 degrees and about 15 degrees (e.g., 8 degrees). The angle between the fourth surface 510 and the second surface 506 of each reflector 500 may be within a range between about 15 degrees and about 25 degrees (e.g., 17 degrees). Each reflector 500 also includes a fifth surface 512 extending between the first surface 504 and the fourth surface 510. The fifth surface 512 may be perpendicular to the fourth surface 510.

FIG. 12B is a cross-sectional view of exemplary reflectors 520. Reflectors 520 may be used in an array of reflectors within each pixel of a fixed reflective display, such as fixed display 122 of FIG. 2A. Each reflector 520 includes a first surface 524 having a first slope and a second surface 526 having a second slope different from the first slope. In this example, the slope of the first surface 524 is less than the slope of the second surface 526. The first surface 524 extends to the second surface 526. In certain exemplary embodiments, the first surface 524 and the second surface 526 may be curved (e.g., concave or convex). Each reflector 520 includes a single triangular shaped portion including the first surface 524 and the second surface 526 on a single side of the reflector 520. Each reflector 520 also includes a third surface 528 extending to the second surface 526 and a fourth surface 530 extending between the third surface 528 and the first surface 524. The third surface 528 may be perpendicular to the fourth surface 530.

The reflectors 500 and 520 including multiple slopes collect more light to be redirected to the viewer compared to reflectors including a single slope. The slopes may be configured based on the given lighting conditions (e.g., radiance of light sources) and the relative positions of the light sources, display, and observer (fixed relative position or a number of relative positions) to maximize the light in the observer's field of view. Reflectors 500 and 520 may be optimized for a specific illumination model as illustrated in FIGS. 3B-3F and for a specific observer's field of view (e.g., a cone angle around the normal viewing direction of plus or minus about 30 degrees). Reflectors 500 and 520 may be optimized for several relative positions of the emitting surface and the observer shown in FIGS. 3B-3F.

Referring back to FIG. 3A, in certain use cases, a symmetric reflector may be desirable. FIG. 3A models the diffuse ambient light inside a room. Lambertian light source 140 illuminates (rays 144) the front surface of the reflective display 142, which is turned arbitrarily at 60 degrees with respect to the light source 140. A viewer 106 (e.g., the viewer's head) may prevent light rays with normal incidence from falling on the reflective display 142.

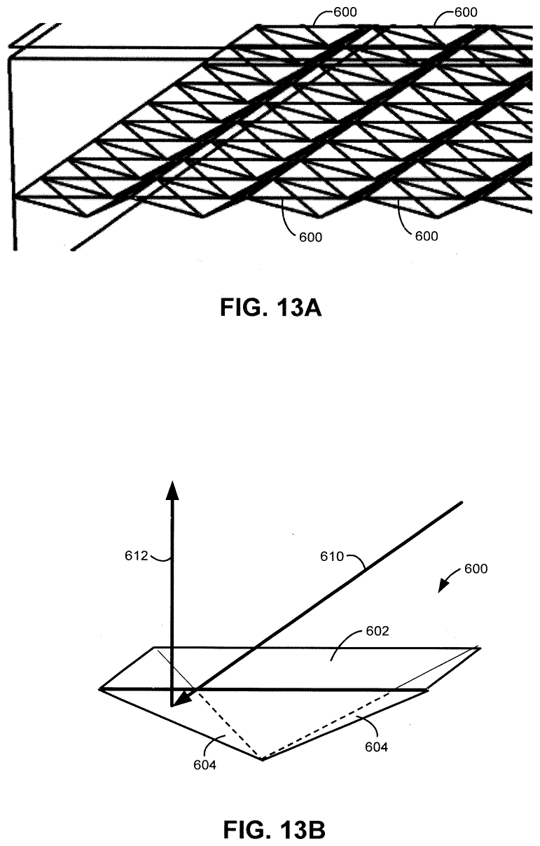

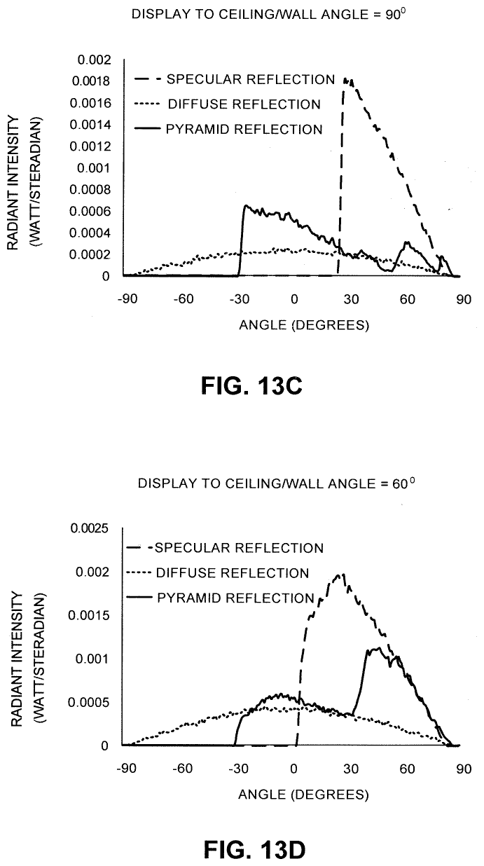

FIG. 13A illustrates an exemplary array of inverted pyramid reflectors 600, and FIG. 13B illustrates one exemplary inverted pyramid reflector 600. Each inverted pyramid reflector 600 includes a base portion 602 and sidewall portions 604. The base portion 602 is transparent (e.g., at least about 85 percent of ambient visible light incident on the base portion passes through the base portion) and the sidewall portions 604 are reflective (e.g., at least about 80 percent of ambient visible light incident on the sidewall portions is reflected back toward the viewer). An angle between opposing sidewall portions 604 may be within a range between about 60 degrees and about 90 degrees. Inverted pyramid reflector 600 has a diffusing profile around incident light direction 610. This light is reflected at a normal viewing angle as indicated at 612.

FIG. 13C is a chart illustrating exemplary angular distributions of the outcoupled light intensity for the inverted pyramid reflectors 600 of FIGS. 13A and 13B. The chart illustrates radiant intensity in watts per steradian versus angle in degrees for specular reflection, diffuse reflection, and inverted pyramid reflection. In this embodiment, the ambient light comes from a diffuse ceiling, or in a horizontal plane in the case of light coming from diffuse walls. The angle between the plane of the reflective display and the ceiling (or wall) is about 90 degrees. Three kinds of reflectors are compared including a specular reflector, a diffuse reflector, and an inverted pyramid reflector. For the inverted pyramid reflector, enhancement of the light intensity in the normal direction towards the viewer relative to the diffuse reflector is about 120 percent. There is about a two time increase of reflected light within a plus or minus about 30 degree cone angle around the normal viewing direction for a configuration of the display at 90 degrees from the emitting surface.

FIG. 13D is a chart illustrating exemplary angular distributions of the outcoupled light intensity for the inverted pyramid reflectors 600 of FIGS. 13A and 13B. The chart illustrates radiant intensity in watts per steradian versus angle in degrees for specular reflection, diffuse reflection, and inverted pyramid reflection. In this embodiment, the ambient light comes from a diffuse ceiling, or in a horizontal plane in the case of light coming from diffuse walls. The angle between the plane of the reflective display and the ceiling (or wall) is about 60 degrees. Three kinds of reflectors are compared including a specular reflector, a diffuse reflector, and an inverted pyramid reflector. For the inverted pyramid reflector, enhancement of the light intensity in the normal direction towards the viewer relative to the diffuse reflector is about 33 percent. The inverted pyramid reflector allows for an increased area to reflect light to the desired direction and thus increase the overall intensity compared to non-inverted pyramid shapes.

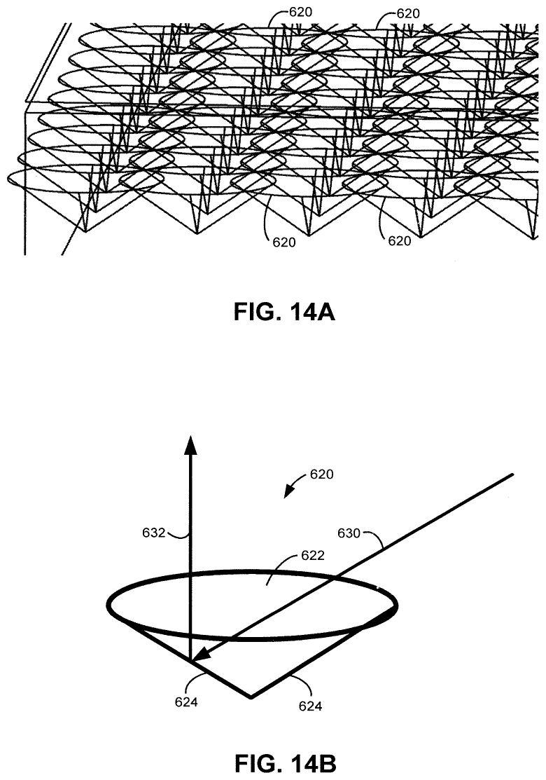

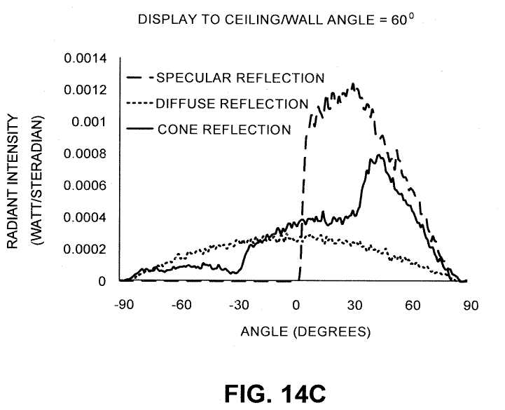

FIG. 14A illustrates an exemplary array of inverted cone reflectors 620, and FIG. 14B illustrates one exemplary inverted cone reflector 620. Each inverted cone reflector 620 includes a base portion 622 and sidewall portions 624. The base portion 622 is transparent and the sidewall portions 624 are reflective. An angle between opposing sidewall portions 624 may be within a range between about 60 degrees and about 90 degrees. Inverted cone reflector 620 has a diffusing profile around incident light direction 630. This light is reflected at-a normal viewing angle as indicated at 632.

FIG. 14C is a chart illustrating exemplary angular distributions of the outcoupled light intensity for the inverted cone reflectors 620 of FIGS. 14A and 14B. The chart illustrates radiant intensity in watts per steradian versus angle in degrees for specular reflection, diffuse reflection, and inverted cone reflection. In this embodiment, the ambient light comes from a diffuse ceiling, or in a horizontal plane in the case of light coming from diffuse walls. The angle between the plane of the reflective display and the ceiling (or wall) is about 60 degrees. Three kinds of reflectors are compared including a specular reflector, a diffuse reflector, and an inverted cone reflector. For the inverted cone reflector, enhancement of the light intensity in the normal direction towards the viewer relative to the diffuse reflector is about 33 percent. The inverted cone reflector allows for an increased area to reflect light to the desired direction and thus increases the overall intensity compared to non-inverted cone shapes.

The reflectors disclosed herein may be fabricated using microimprinting technology. A master stamp may be generated with the desired features. A lacquer may be coated on a glass substrate and then imprinted with the stamps and cured. The resulting structures may then be metallized to increase their reflectivity.

It will be apparent to those skilled in the art that various modifications and variations can be made to embodiments of the present disclosure without departing from the spirit and scope of the disclosure. Thus, it is intended that the present disclosure cover such modifications and variations provided they come within the scope of the appended claims and their equivalents.

What is claimed is:

1. A reflective display comprising:
a plurality of pixels, each pixel comprising an active area; and
an array of reflectors within the active area of each pixel, each reflector of the array of reflectors is directly adjacent to another reflector of the array of reflectors, each reflector of the array of reflectors is entirely reflective, and each reflector of the array of reflectors comprises a curved first surface.

2. The reflective display of claim 1, wherein the first surface is convex.

3. The reflective display of claim 1, wherein the first surface is concave.

4. The reflective display of claim 1, wherein each reflector of the array of reflectors comprises a planer second surface extending to the first surface.

5. The reflective display of claim 4, wherein the second surface is rectangular.

6. The reflective display of claim 4, further comprising:
a third surface extending between the first surface and the second surface,
wherein a first angle between the second surface and the first surface is less than a second angle between the second surface and the third surface.

7. The reflective display of claim 1, wherein each reflector of the array of reflectors is arranged at an angle to a directly adjacent reflector of the array of reflectors within a range between about 15 degrees and about 25 degrees.

8. The reflective display of claim 1, wherein each reflector of the array of reflectors is arranged in an opposite orientation to a directly adjacent reflector of the array of reflectors.

9. The reflective display of claim 1, further comprising:
a glass substrate;
wherein the array of reflectors are arranged on the glass substrate.

10. The reflective display of claim 9, further comprising:
a planarization layer encapsulating the array of reflectors.

11. The reflective display of claim 9, further comprising:
a liquid crystal layer within each pixel,
wherein the array of reflectors directly contacts the liquid crystal layer.

12. A reflective display comprising:
a plurality of pixels, each pixel comprising an active area; and
an array of reflectors within the active area of each pixel, each reflector of the array of reflectors is directly adjacent to another reflector of the array of reflectors, each reflector of the array of reflectors is entirely reflective, and each reflector of the array of reflectors comprises a first surface having a first slope and a second surface having a second slope different from the first slope.

13. The reflective display of claim 12, wherein each reflector of the array of reflectors comprises a third surface extending between the first surface and the second surface.

14. The reflective display of claim 12, wherein the first surface extends to the second surface.

15. The reflective display of claim 12, wherein each reflector of the array of reflectors comprises a first triangular shaped portion comprising the first surface and a second triangular shaped portion comprising the second surface.

16. The reflective display of claim 12, wherein each reflector of the array of reflectors comprises a single triangular shaped portion comprising the first surface and the second surface on a single side of the reflector.

17. The reflective display of claim 12, wherein the first surface and the second surface are curved.

18. A reflective display comprising:
a plurality of pixels, each pixel comprising an active area; and
an array of reflectors within the active area of each pixel, each reflector of the array of reflectors is directly adjacent to another reflector of the array of reflectors, and each reflector of the array of reflectors comprises an inverted pyramid or cone.

19. The reflective display of claim 18, wherein each reflector of the array of reflectors comprises a base portion and sidewall portions, and
wherein the base portion is transparent and the sidewall portions are reflective.

20. The reflective display of claim 19, wherein an angle between opposing sidewall portions is within a range between about 60 degrees and about 90 degrees.
